(19) United States
(12) Patent Application Publication
(10) Pub. No.: US 2025/0293942 A1
(43) Pub. Date: Sep. 18, 2025

(54) MACHINE LEARNING FALLBACK MODEL FOR WIRELESS DEVICE

(71) Applicant: Telefonaktiebolaget LM Ericsson (PUBL), Stockholm (SE)

(72) Inventors: Jingya LI, GÖTEBORG (SE); Mårten Sundberg, ÅRSTA (SE); Mattias Frenne, UPPSALA (SE); Yufei Blankenship, KILDEER, IL (US); Andres Reial, HÖLLVIKEN (SE); Daniel Chen Larsson, LUND (SE)

(21) Appl. No.: 18/859,849

(22) PCT Filed: Apr. 28, 2023
(86) PCT No.: PCT/IB2023/054455

§ 371 Date: Oct. 24, 2024

Related U.S. Application Data
(60) Provisional application No. 63/363,781, filed on Apr. 28, 2022.

(51) Int. Cl. H04L 41/16; H04B 7/06; H04W 8/22

(52) U.S. Cl. CPC H04L 41/16; H04B 7/0626; H04W 8/22

(57) ABSTRACT

According to some embodiments, a method is performed by a wireless device for fallback operation of a machine learning (ML) model. The method comprises: transmitting a message indicating a capability of the wireless device for supporting a combination of at least one ML-based feature for a functionality and at least one fallback feature for the functionality to a network node; operating the at least one ML-based feature for the functionality; and operating the at least one fallback feature for the functionality.

### TECHNICAL FIELD

Embodiments of the present disclosure are directed to wireless communications and, more particularly, to machine learning fallback model for a wireless device.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Artificial Intelligence (AI) and Machine Learning (ML) are considered, both in academia and industry, as promising tools to optimize the design of the air-interface in wireless communication networks. Example use cases include: using autoencoders for channel state information (CSI) compression to reduce the feedback overhead and improve channel prediction accuracy; using deep neural networks for classifying line-of-sight (LOS) and non-LOS (NLOS) conditions to enhance positioning accuracy; using reinforcement learning for beam selection at the network side and/or the user equipment (UE) side to reduce signaling overhead and beam alignment latency; and using deep reinforcement learning to learn an optimal precoding policy for complex multiple-input multiple-output (MIMO) precoding problems.

Third Generation Partnership Project (3GPP) new radio (NR) Release 18 standardization work includes a study item on AI/ML for the NR air interface. The study item will explore the benefits of augmenting the air-interface with features enabling improved support of AI/ML based algorithms for enhanced performance and/or reduced complexity/overhead. Through studying a few selected use cases (CSI feedback, beam management, and positioning), the study item intends to lay the foundation for future air-interface use cases leveraging AI/ML techniques.

When applying AI/ML on air interface use cases, different levels of collaboration between network nodes and UEs may be considered. One use case is no collaboration between network nodes and UEs. In this case, a proprietary ML model operating with the existing standard air-interface is applied at one end of the communication chain (e.g., at the UE side), and the model life cycle management (e.g., model selection/training, model monitoring, model retraining, model update) is done at this node without inter-node assistance (e.g., assistance information provided by the network node).

Another use case is limited collaboration between network nodes and UEs. In this case, a ML model is operating at one end of the communication chain (e.g., at the UE side), but this node gets assistance from the node(s) at the other end of the communication chain (e.g., a next generation Node B (gNB)) for its AI model life cycle management (e.g., for training/retraining the AI model, model update).

A third use case is joint ML operation between network nodes and UEs. In this case, the AI model may be split with one part located at the network side and the other part located at the UE side. Thus, the AI model includes joint training between the network and UE, and the AI model life cycle management involves both ends of a communication chain.

Building the AI model, or any machine learning model, includes several development steps where the actual training of the AI model is just one step in a training pipeline. An important part in AI development is the ML model lifecycle management. An example is illustrated in FIG. 1.

FIG. 1 is an illustration of training and inference pipelines, and their interactions within a model lifecycle management procedure. The model lifecycle management typically consists of a training (re-training) pipeline, a deployment stage to make the trained (or re-trained) AI model part of the inference pipeline, an inference pipeline, and a drift detection stage that informs about any drifts in the model operations.

The training (re-training) pipeline may include data ingestion, data pre-processing, model training, model evaluation, and model registration. Data ingestion refers to gathering raw (training) data from a data storage. After data ingestion, there may be a step that controls the validity of the gathered data.

Data pre-processing refers to feature engineering applied to the gathered data, e.g., it may include data normalization and possibly a data transformation required for the input data to the AI model.

Model training refers to the actual model training steps as previously outlined.

Model evaluation refers to benchmarking the performance to a model baseline. The iterative steps of model training and model evaluation continues until the acceptable level of performance (as previously exemplified) is achieved.

Model registration refers to registering the AI model, including any corresponding AI-metadata that provides information on how the AI model was developed, and possibly AI model evaluations performance outcomes.

The deployment stage makes the trained (or re-trained) AI model part of the inference pipeline.

The inference pipeline may include data ingestion, data pre-processing, model operational, and data and model monitoring. Data ingestion refers to gathering raw (inference) data from a data storage.

The data pre-processing stage is typically identical to corresponding processing that occurs in the training pipeline.

Model operational refers to using the trained and deployed model in an operational mode.

Data and model monitoring refers to validating that the inference data are from a distribution that aligns well with the training data, as well as monitoring model outputs for detecting any performance, or operational, drifts.

A drift detection stage informs about any drifts in the model operations.

There currently exist certain challenges. For example, there is a category of use cases where a ML model is deployed at the UE side and the model output is reported from the UE to a network node. Based on the model output, the network takes an action(s) that affect(s) the current or subsequent wireless communications between the network and the UE.

There may be cases where the ML model deployed at the UE does not generalize to some scenarios, thus, the ML model output (e.g., the estimated channel quality indicator (CQI) values, predicted channel state information (CSI) in one or more subbands, predicted beam measurements in the time and/or spatial domain, the estimated UE location, etc.) are not correct and/or the error interval is higher than acceptable level(s) and/or the accuracy (or accuracy interval(s)) is not acceptable. Because the network performs transmission/reception actions based on the ML-model output, incorrect model output(s) can result in wrong decisions being made at the network side, and thereby, adversely affecting the wireless communication performance.

For example, based on a wrong beam measurement prediction reported by the UE, the network may activate a transmission configuration information (TCI) state (and/or trigger a beam switching) at the UE that does not correspond to a beam the UE is able to detect (or has poor coverage performance), The wrong decisions may lead to beam failure, radio link failure, poor throughput, and/or too much signaling due to subsequent CSI measurement configuration(s)/activations.

In another category of use cases, a ML model is split into two parts, with one part located at the network side and the other part located at the UE side. One example use case is autoencoder (AE)-based CSI feedback/report, where an encoder is operated at a UE to compress the estimated wireless channel, and the output of the encoder (the compressed wireless channel information estimates) is reported from the UE to a gNB. The gNB uses a decoder to reconstruct the estimated wireless channel information. Thus, the ML model for this use case category requires joint operation between the network and UE. If the part of the ML model located at the UE is not functioning well, it will impact the overall performance of the related functionality (e.g., CSI report).

When detecting a performance drift of a ML model, it may be possible to initiate new data collection and retrain the ML model. However, such data collection and model retraining may take a long time. Depending on UE capabilities, online model retraining may not be feasible.

When a ML model is used for a critical functionality, it is important to ensure that robustness and resilience performance of the functionality is not impacted if the ML model is not performing well. A quick action needs to be taken when detecting or predicting a performance issue of the active ML model(s) associated to this critical functionality.

For the above-mentioned ML use case categories, the current NR standard does not have a mechanism to ensure/maintain the robustness and resilience of a critical functionality when the ML model operated for this functionality is not performing well.

### SUMMARY

As described above, certain challenges currently exist with machine learning fallback model for a wireless device. Certain aspects of the present disclosure and their embodiments may provide solutions to these or other challenges.

For example, particular embodiments include a user equipment (UE) that is capable of operating at least one machine learning (ML)-based feature associated for a functionality and also supports at least a fallback feature for the functionality. The UE indicates to the network its capability of supporting a combination of at least one ML-based feature and a fallback feature for the functionality.

When a performance problem is detected for at least one ML-based feature, the UE may either be instructed by the network to switch to a fallback feature for the functionality or autonomously switch to a fallback feature and indicate the feature switching to the network.

According to some embodiments, a method at a UE operating with at least one ML-based feature associated to a functionality comprises sending a message indicating its capability of supporting a combination of at least one ML-based feature and at least one fallback feature for the associated functionality to a network node.

In particular embodiments, the at least one ML-based feature is based on one or multiple ML models, which are located at the UE. In particular embodiments, the at least one ML-based feature is based on one ML model that is split in two parts, with one part located at the UE and the other part located at the network node. In particular embodiments, the at least one ML-based feature is based on multiple ML models, with part of the models located at the UE and the rest of the models located at the network.

In particular embodiments, the fallback feature is a feature that can fulfill comparable functionalities as the ML-based feature, but is not preferred compared to the alternative by ML.

In particular embodiments, the fallback feature is a feature that has same or lower capabilities than the ML-based feature(s). In particular embodiments, the fallback feature is a feature that has higher capabilities than the ML-based feature, but the fallback feature is not preferred due to other reasons, including higher complexity, longer processing delay, higher power consumption, excessive consumption of time/frequency resources, etc. The definition of higher capability depends on the functionality, e.g., for channel state information (CSI), higher capability may refer to more accurate CSI (including subband selection, rank indicator (RI), precoding matrix indicator (PMI), modulation and coding scheme (MCS)) feedback; for beam management, higher capability may refer to higher accuracy in identifying the best candidate beam; for positioning, higher capability may refer to more accurate estimation of the UE position.

In particular embodiments, the fallback feature is based on a classical non-ML based algorithm. In particular embodiments, the fallback feature is a ML-based algorithm.

In particular embodiments, the message indicates whether the at least one fallback feature and the ML-based feature(s) may be executed simultaneously. The message, indicating its capability of supporting a combination of at least one ML-based feature and at least one fallback feature for the associated functionality, is (part of) a UE capability parameter(s) that is/are associated to the functionality. The message may explicitly indicate that a UE supporting one ML-based feature shall also support a fallback feature for the associated functionality. The message may include at least one entry for mixed codebook combinations, where one codebook type is associated to a ML-based feature. The message may indicate that the UE may support different combinations of at least one ML-based feature and at least one fallback feature between frequency division duplex (FDD) and time division duplex (TDD), and/or between FR1 and FR2, and/or between different bands.

In particular embodiments, the message, indicating its capability of supporting a combination of at least one ML-based feature and at least one fallback feature for the associated functionality, is a Radio Resource Control (RRC) message, medium access control (MAC) control element (CE), Msg1, MsgA, Msg3, a combination of Msg1 and Msg3, uplink control information (UCI), or scheduling control information (SCI). The message may be sent when the UE activates/switches-on/registers at least one ML model associated to the ML-based feature.

In particular embodiments, the method further comprises the UE receiving from the network node a first configuration message, which configures the UE to perform/operate at least a ML-based feature and at least a fallback feature simultaneously for the associated functionality.

In particular embodiments, the method further comprises the UE receiving from the network node a second configuration message, which configures the UE to deactivate/stop/switch-off at least one ML-based feature and active/switch-on the associated fallback feature(s) for the associated functionality. The network may send the second configuration message when it detects/predicts a performance failure of at least one ML-based feature for the associated functionality. The method further comprises, upon receiving the second configuration message from the network node, the UE de-activates/stops the ML-based feature(s) and activates/switches-on the fallback feature(s) according to the information contained in this second configuration message.

In particular embodiments, the method further comprises the UE monitoring the ML-model performance of the one or more ML-based feature(s). The UE detects or predicts a performance failure of at least one ML-based feature for the associated functionality, and it autonomously de-actives/stops at least the detected ML-based feature(s) and actives/switches-on at least the associated fallback feature(s). The method further comprises the UE indicating about the feature switching information (e.g., the de-activated/stopped/switched-off ML-based feature(s)) to the network node.

In particular embodiments, when there are multiple fallback features supported by the UE for the associated functionality, an order/sequence for the UE to perform feature switching (e.g., firstly switching to the fallback feature 1, if failed, then switching to the fallback feature 2, etc.) is preconfigured by the network node or predefined in the standardization specification.

In particular embodiments, examples of a functionality include CSI reporting, time-domain beam prediction or beam selection, spatial-domain beam prediction or beam selection, beam failure prediction, radio link failure prediction, mobility management (e.g., handover decision), location estimation, link adaptation (e.g., MCS selection).

In particular embodiments, the functionality is CSI reporting, the at least one ML-based feature is a ML-based CSI reporting, and the at least one fallback feature is a legacy CSI reporting type (e.g., Type 2 codebook based CSI reporting, or eType 2 codebook based CSI reporting, or Type 1 Single Panel based CSI reporting).

According to some embodiments, a method at a network node comprises receiving a message from a UE indicating the UE's capability of supporting a combination of at least one ML-based feature and at least one fallback feature for a functionality.

In particular embodiments, the method further comprises, upon receiving the UE capability information, the network node sends a first configuration message to instruct the UE to perform/operate at least a ML-based feature and at least a fallback feature simultaneously for the associated functionality.

In particular embodiments, the method further comprises, upon detecting/predicting a performance failure of at least one ML-based feature for the associated functionality, the network node sends a second configuration message to instruct the UE to deactivate/stop/switch-off at least the detected/predicted ML-based feature(s) that (may) have performance issues and active/switch-on the associated fallback feature(s).

In particular embodiments, the method further comprises receiving an indication from the UE about its feature switching information (e.g., the de-activated/stopped/switched-off ML-based feature(s) and the activated/switched-on fallback feature(s)) for the associated functionality.

In particular embodiments, the method further comprises the network node deactivates/stops/switches-off the associated ML-models at the network side for at least the deactivated ML-based feature(s), e.g., for the case where the ML-based feature is based on a ML model that is split in two parts, with one part located at the UE and the other part located at the network, or for the case where the ML-based feature is based on multiple ML models, with part of the models located at the UE and the rest of the models located at the network.

In particular embodiments, the method further comprises the network node sends an adjusted configuration or/and scheduling message for the UE accordingly. The adjusted configuration message or/and scheduling message adjustment may include an updated reference signal resource configuration for UE measurements, or/and an updated CSI reporting configuration for the UE to report CSI using the fallback feature.

According to some embodiments, a method is performed by a wireless device for fallback operation of a ML model. The method comprises: transmitting a message indicating a capability of the wireless device for supporting a combination of at least one ML-based feature for a functionality and at least one fallback feature for the functionality to a network node; operating the at least one ML-based feature for the functionality; and operating the at least one fallback feature for the functionality.

In particular embodiments, the at least one ML-based feature is based on one ML model that is split in two parts, with one part located at the wireless device and the other part located at the network node.

In particular embodiments, the at least one fallback feature is a feature that fulfills comparable functionalities as the ML-based feature, but is not preferred compared to the ML-based feature. The at least one fallback feature may be a feature that has higher capabilities than the ML-based feature, but the fallback feature is not preferred. The at least one fallback feature may be based on a non-ML-based algorithm or it may be another ML-based algorithm (e.g., a more general purpose ML-based algorithm).

In particular embodiments, the message indicates whether the at least one fallback feature and the at least one ML-based feature may be executed simultaneously (e.g., to compare performance between the two).

In particular embodiments, the method further comprises receiving a first configuration message that configures the wireless device to operate the at least one ML-based feature.

In particular embodiments, the method further comprises receiving a first configuration message that configures the wireless device to operate the at least one ML-based feature and at least a fallback feature simultaneously.

In particular embodiments, the method further comprises receiving a second configuration message that configures the wireless device to deactivate the at least one ML-based feature and activate the at least one fallback feature.

In particular embodiments, the method further comprises determining autonomously to deactivate the at least one ML-based feature and activate the at least one fallback feature.

According to some embodiments, a wireless device comprises processing circuitry operable to perform any of the methods of the wireless device described above.

Also disclosed is a computer program product comprising a non-transitory computer readable medium storing computer readable program code, the computer readable program code operable, when executed by processing circuitry to perform any of the methods performed by the wireless device described above.

According to some embodiments, a method is performed by a network node for configuring a wireless device for fallback operation of a ML model. The method comprises: receiving from a wireless device a message indicating a capability of the wireless device for supporting a combination of at least one ML-based feature for a functionality and at least one fallback feature for the functionality; determining to activate the at least one fallback feature; and transmitting a configuration message to the wireless device that configures the wireless device to deactivate the at least one ML-based feature and activate the at least one fallback feature.

In particular embodiments, the at least one ML-based feature is based on one ML model that is split in two parts, with one part located at the wireless device and the other part located at the network node.

In particular embodiments, the message indicates whether the at least one fallback feature and the at least one ML-based feature may be executed simultaneously.

In particular embodiments, the method further comprises transmitting a configuration message to the wireless device that configures the wireless device to operate the at least one ML-based feature.

In particular embodiments, the method further comprises transmitting (1114) a configuration message that configures the wireless device to operate the at least one ML-based feature and at least a fallback feature simultaneously.

Another computer program product comprises a non-transitory computer readable medium storing computer readable program code, the computer readable program code operable, when executed by processing circuitry to perform any of the methods performed by the network nodes described above.

Certain embodiments may provide one or more of the following technical advantages. For example, particular embodiments ensure that a UE supporting a ML-based feature for a critical functionality shall also support a fallback feature for the functionality. By sharing such UE capability information to the network node, the UE (and the network node) may switch to a fallback feature when detecting/predicting a performance problem of the ML-based feature. Thus, particular embodiments ensure/maintain the robustness and resilience of a critical functionality when the ML model operated for the functionality is not performing well.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is an illustration of training and inference pipelines, and their interactions within a model lifecycle management procedure;

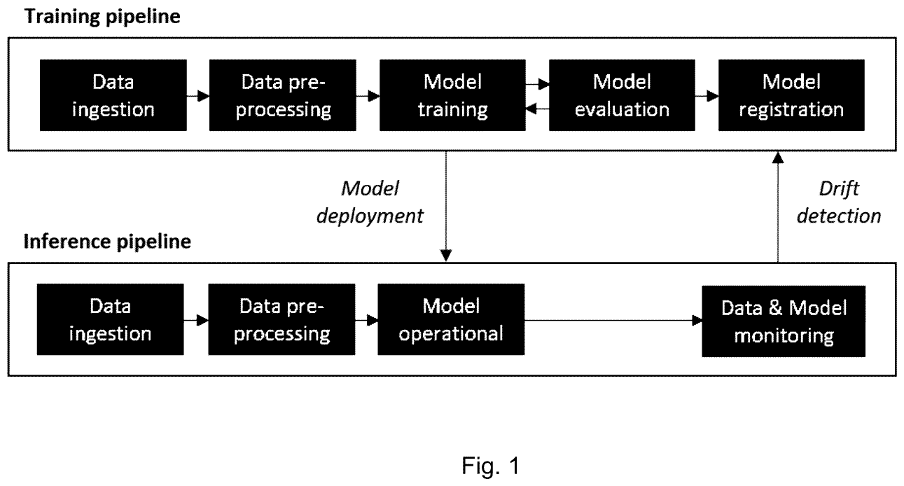

FIG. 2 is a flow chart illustrating an example of network node assisted ML-based feature fallback;

FIG. 3 is a flow chart illustrating an example of UE autonomous ML-based feature fallback and reporting its actions to the network node;

FIG. 4 illustrates an example communication system, according to certain embodiments;

FIG. 5 illustrates an example UE, according to certain embodiments;

FIG. 6 illustrates an example network node, according to certain embodiments;

FIG. 7 illustrates a block diagram of a host, according to certain embodiments;

FIG. 8 illustrates a virtualization environment in which functions implemented by some embodiments may be virtualized, according to certain embodiments;

FIG. 9 illustrates a host communicating via a network node with a UE over a partially wireless connection, according to certain embodiments;

FIG. 10 illustrates a method performed by a wireless device, according to certain embodiments; and

FIG. 11 illustrates a method performed by a network node, according to certain embodiments.

### DETAILED DESCRIPTION

As described above, certain challenges currently exist with machine learning fallback model for a wireless device. Certain aspects of the present disclosure and their embodiments may provide solutions to these or other challenges.

For example, particular embodiments include a user equipment (UE) that is capable of operating at least one machine learning (ML)-based feature associated for a functionality and also supports at least a fallback feature for the functionality. The UE indicates to the network its capability of supporting a combination of at least one ML-based feature and a fallback feature for the functionality.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

As used herein, the terms “ML model” and “AI model”, “AI based feature” and “ML-based feature” are interchangeable. An AI/ML model may be defined as a functionality or be part of a functionality that is deployed/implemented in a first node. This first node may receive a message from a second node indicating that the functionality is not performing correctly, e.g. prediction error is higher than a pre-defined value, error interval is not in acceptable levels, or prediction accuracy is lower than a pre-defined value.

Further, an AI/ML model may be defined as a feature or part of a feature that is implemented/supported in a first node. This first node may indicate the feature version to a second node. If the ML model is updated, the feature version may be changed by the first node.

A ML model may correspond to a function that receives one or more inputs (e.g., measurements) and provide as output one or more prediction(s)/estimates of a certain type. In one example, a ML-model may correspond to a function receiving as input the measurement of a reference signal at time instance t0 (e.g., transmitted in beam-X) and provide as output the prediction of the reference signal in timer t0+T. In another example, a ML model may correspond to a function receiving as input the measurement of a reference signal X (e.g., transmitted in beam-x), such as a synchronization signal block (SSB) with index ‘x’, and provide as output the prediction of other reference signals transmitted in different beams, e.g., reference signal Y (e.g., transmitted in beam-x), such as an SSB with index ‘x’.

Another example is a ML model to aid in channel state information (CSI) estimation. In such a setup, the ML model is a specific ML model at the UE and a ML model at the network side. Jointly both ML models provide joint network functionality. The function of the ML model at the UE is to compress a channel input and the function of the ML model at the network side is to decompress the received output from the UE.

It is further possible to apply a ML model for positioning wherein the input may be a channel impulse related to a certain reference point (typically a TP (transmit point)) in time. The purpose on the network side is to detect different peaks within the impulse response that reflects the multipath experienced by the radio signals arriving at the UE side. Another positioning method is to input multiple sets of measurements into an ML network and based on that derive an estimated position of the UE.

Another ML model is an ML model to aid the UE in channel estimation or interference estimation for channel estimation. The channel estimation may, for example, be for the physical downlink shared channel (PDSCH) and be associated with specific set of reference signals patterns that are transmitted from the network to the UE. The ML model is part of the receiver chain within the UE and may not be directly visible within the reference signal pattern that is configured/scheduled to be used between the network and UE. Another example of an ML-model for CSI estimation is to predict a suitable CQI, PMI, RI, CRI (CSI-RS resource indicator) or similar value into the future. The future may be a certain number of slots after the UE has performed the last measurement or targeting a specific slot in time within the future.

The network node may be one of a generic network node, gNB, base station, unit within the base station to handle at least some operations of the functionality, relay node, core network node, a core network node that handles at least some operations of the functionality, a device supporting device-to-device (D2D) communication, a location management function (LMF) or other types of location server.

In the use cases described herein, a ML based feature is at least in part at the UE. In one type of use case, a ML-based feature may be based on multiple ML models that are deployed at the UE side (e.g., ML model is located at the UE side for its RX beam prediction). In another type of use case, a ML-based feature is based on one ML model that is split in two parts, with one part located at the UE and the other part located at the network node (e.g., AE-based CSI feedback/report). In yet another type of use case, a ML-based feature is based on multiple ML models, with part of the models located at the UE and the rest of the models located at the network (e.g., ML-based beam-pair prediction between a network node and a UE, where a ML-model is located at the network node for its TX beam prediction and another ML-model is located at the UE for its RX beam prediction).

When detecting a performance drift of a ML model, one option is to initiate new data collection and retrain the ML model. However, such data collection and model retraining may take a long time. Depending on UE capabilities, online model retraining may not be feasible.

When a ML model is used for a critical functionality, it is important to ensure that robustness and resilience performance of the functionality will not be impacted if the ML model is not performing well. A quick action needs to be taken when detecting or predicting a performance issue of the active ML model(s) associated with the critical functionality.

Particular embodiments described herein enable a UE operating with at least one ML-based feature for a critical functionality to quickly switch to a fallback feature for the functionality when detecting or predicting a performance issue of the active ML model(s) associated with the critical functionality.

A fallback feature may be a feature that has same or lower capabilities than the ML-based feature(s). A fallback feature may be based on a classical non-ML-based algorithm. For example, consider the AE-based CSI feedback/report use case, the functionality is CSI feedback/reporting, one ML-based feature for this functionality may be AE-based CSI feedback/report (dual-sided ML algorithm), and one fallback feature may be a legacy CSI reporting type (e.g., Type 2 codebook based CSI reporting, or eType 2 codebook based CSI reporting, or Type 1 Single Panel based CSI reporting).

In some embodiments, the fallback feature may have higher capabilities than the ML-based feature, but the fallback feature is not preferred due to other reasons, including higher complexity, longer processing delay, higher power consumption, excessive consumption of time/frequency resources, etc. In general, the fallback feature fulfills comparable functionalities as the ML-based feature, but is not preferred compared to the alternative by ML.

What is considered higher capability may depend on the function. For example, for CSI, higher capability may refer to more accurate CSI (including sub-band selection, RI, PMI, MCS) feedback. For beam management, higher capability may refer to higher accuracy in identifying the best candidate beam. For positioning, higher capability may refer to more accurate estimation of the UE position.

While particular examples focus on embodiments where the fallback feature is a classical non-ML based algorithm, in some embodiments the fallback feature may also be ML-based.

In one example, the UE is capable of supporting at least two ML models, where the first ML model is a generalized model that can be used in a wide variety of deployments (e.g., indoor and outdoor, dense urban and rural, high mobility and low mobility), and the second ML model is a specialized model that is trained for best performance for a particular deployment (e.g., indoor factory). In this case, the first ML model may be used as the fallback feature, while the second model is activated as the preferred feature when the UE is deployed in the trained environment. In general, one ML model is more basic and may be used as the fallback feature, while another ML model is more sophisticated and may be used as the preferred model unless the preferred model is considered inappropriate, e.g., due to excessive error detected during a monitoring period.

In another example, the at least two ML models may also be different versions or models/algorithms for the same functionality considering this independently from if one is more generalized than the second one. The two ML-models are identified by a model ID or model version in that case. They may, for example, support CSI report both of them but the resolution or details out of the reports may also differ. Similar aspect may also be generalized in that the two ML-models only support a subset of the feature or lower resolution of the other one.

In another example, the UE is capable of supporting at least two ML models, where the at least two ML models use different input and/or different output. In some embodiments, the first ML model is equivalent to the classical non-ML based algorithm in terms of input and output of the algorithm, i.e., the first ML model does not demand any interface change in terms of signaling, configuration, measurement, report, etc. Thus the ‘black box’ of the functionality can be realized by the classical algorithm or the first ML model equivalently, and the UE does not have to notify the network node (and the network node may not be aware) whether the UE is running the classical algorithm or the first ML model. This first ML model can be used as the fallback feature. The second ML model requires explicit collaboration between the network node and the UE to fulfill more advanced algorithm, where the explicit collaboration is reflected in the change to the Uu interface compared to classical algorithm, including different configuration of RS, different measurement mode, different report from UE, etc.

Some embodiments include a UE Capability Indication. To support a UE switching from one ML-based feature to a fallback feature for a critical functionality, the UE is capable of supporting a combination of the ML-based feature and the fallback feature for the functionality.

In some embodiments, a UE that is capable of operating at least one ML-based feature associated for a functionality is required to support also at least a fallback feature for the functionality.

The requirement may be explicitly defined as part of the UE capability parameter in specifications. For example, it can be explicitly written in the UE capability parameter in the specification that a UE supporting the ML-based feature X shall also support a fallback feature Y for the associated functionality. The UE can indicate this capability information to the network node in different ways as described below.

In some embodiments, the UE indicates its capability of supporting a combination of at least one ML-based feature and at least one fallback feature for the associated functionality in its UE capability report.

In some embodiments, a UE that is capable of operating at least one ML-based feature(s) associated to a functionality sends a message indicating its capability of supporting a combination of at least one ML-based feature and at least one fallback feature for the associated functionality to a network node.

In some embodiments, the message indicating its capability of supporting a combination of at least one ML-based feature and at least one fallback feature for the associated functionality is (part of) a UE capability parameter(s) that is/are associated to the functionality.

In some embodiments, the message explicitly indicates that a UE supporting one ML-based feature shall also support a fallback feature for the associated functionality.

In some embodiments, the UE indicates its capability of supporting a combination of at least one ML-based feature in its UE capability report and it has support for at least one fallback feature for the associated functionality that is not declared explicitly as a capability. The network can request a fallback function for many UEs regardless of their capabilities. For example, the UE may declare a capability for ML-based demodulation reference signal (DMRS) channel estimation. This may be in the form of supporting different DMRS patterns or different receiver requirements for a specific DMRS pattern. All UEs may also implement conventional, non-ML channel estimation, which use may be mandated by the network.

For example, for the codebook-based CSI feedback/report functionality, a UE capability parameter, codebookComboParametersAddition-r16, was introduced in NR Rel-16 [3GPP TS 38.306 v 17.0.0], which indicates the UE supports the mixed codebook combinations, as shown in the table below.

| | | | | |
|---|---|---|---|---|
| Definitions for parameters | Per | M | FDD − | FR1 − |
| | | | TDD | FR2 |
| | | | DIFF | DIFF |
| codebookComboParametersAddition-r16 | Band | No | N/A | N/A |
| Indicates the UE supports of the mixed codebook combinations and the | | | | |
| corresponding parameters supported by the UE. | | | | |
| For mixed codebook types, UE reports support active CSI-RS resources and ports | | | | |
| for up to 4 mixed codebook combinations in any slot. The following is the possible | | | | |
| mixed codebook combinations: | | | | |
| {Type 1 Single Panel, Type 2, Null} | | | | |
| {Type 1 Single Panel, Type 2 with port selection, Null} | | | | |
| {Type 1 Single Panel, eType 2 with R = 1, Null} | | | | |
| {Type 1 Single Panel, eType 2 with R = 2, Null} | | | | |
| {Type 1 Single Panel, eType 2 with R = 1 and port selection, Null} | | | | |
| {Type 1 Single Panel, eType 2 with R = 2 and port selection, Null} | | | | |
| {Type 1 Single Panel, Type 2, Type 2 with port selection} | | | | |
| {Type 1 Multi Panel, Type 2, Null} | | | | |
| {Type 1 Multi Panel, Type 2 with port selection, Null} | | | | |
| {Type 1 Multi Panel, eType 2 with R = 1, Null} | | | | |
| {Type 1 Multi Panel, eType 2 with R = 2, Null} | | | | |
| {Type 1 Multi Panel, eType 2 with R = 1 with port selection, Null} | | | | |
| {Type 1 Multi Panel, eType 2 with R = 2 with port selection, Null} | | | | |
| {Type 1 Multi Panel, Type 2, Type 2 with port selection} | | | | |
| Parameters for each mixed codebook supported by the UE: | | | | |
| supportedCSI-RS-ResourceListAdd-r16 indicates the list of supported CSI- | | | | |
| RS resources in a band by referring to codebookVariantsList. The following | | | | |
| parameters are included in codebookVariantsList: | | | | |
| For supportedCSI-RS-ResourceListAdd-r16 related to the additional codebooks: | | | | |
| The minimum of maxNumberTxPortsPerResource is ‘p4’; | | | | |
| The minimum value of totalNumberTxPortsPerBand is 4. | | | | |
| If a UE reports one or more mixed codebook combinations, then usage of active | | | | |
| CSI-RS resources and ports for multiple codebooks in any slot is allowed only | | | | |
| within those combinations. For coexisting of mixed codebooks in any slot, gNB | | | | |
| needs to consider the mixed codebook combination capability as well as per | | | | |
| codebook capability of each codebook type in the mixed codebook combination. | | | | |
| UE indicates support of a codebook type in the mixed codebook combination shall | | | | |
| indicates support of the individual codebook type in the per band capability. | | | | |

For the CSI feedback/reporting use case, the message indicating the UE's capability of supporting a combination of a ML-based feature (e.g., ML-based CSI feedback/report) and at least one fallback feature (e.g., Type 1 Single Panel) may be defined by a similar UE capability parameter, e.g., codebookComboParametersAddition-r18 with a new entry {Type 1 Single Panel, Type 3}, where Type 3 denotes the ML-based CSI feedback feature. For an advanced UE, a new entry that represents a combination of more than two codebook types may be added, e.g., {Type 1 Single Panel, Type 2, Type 3}.

In some embodiments, the message indicating the UE capability of supporting a combination of at least one ML-based feature and at least one fallback feature for a CSI reporting functionality is (part of) a UE capability parameter. The UE capability parameter includes at least one entry for mixed codebook combinations, where one codebook type is associated to a ML-based feature.

In some embodiments, the message also indicates that the UE may support different combinations of at least one ML-based feature and at least one fallback feature between FDD and TDD, and/or between FR1 and FR2 (or other spectrum ranges), feature sets, and/or between different bands.

In some embodiments, when a UE activates/switches-on/registers at least one ML model for a ML-base feature, it sends the information about this ML-based feature (e.g., ML model ID(s)) to the network node, in addition, it may also send the fallback feature(s) associated with the ML-based feature.

The message containing the ML-based feature information and the message containing the associated fallback feature(s) for the ML-based feature may be the same message or different messages.

A UE may activate/switch-on/register a ML model and indicates such actions to the network node by, e.g., initiating a random-access procedure, or sending a RRC message, or MAC CE message. If the information payload size is small, the indication may also be done using uplink control information (UCI) transmissions (e.g., encode such actions as part of UCI, and the UE sends it to a gNB) or sidelink control information (SCI) transmissions (e.g., encode such actions as part of SCI, and the UE sends it to another UE).

In some embodiments, the message is sent when the UE activates/switches-on/registers at least one ML model associated to the ML-based feature.

In some embodiments, the message indicating its capability of supporting a combination of at least one ML-based feature and at least one fallback feature for the associated functionality is an RRC message, MAC CE, Msg1, MsgA, Msg3, a combination of Msg1 and Msg3, UCI, or SCI.

In some embodiments, the UE indication of its capability of supporting a combination of at least one ML-based functionality and at least one fallback feature for the same functionality includes an indication that the ML and fallback features may be executed simultaneously. Alternatively, the UE may indicate that they may be executed one by one but not simultaneously.

Some embodiments include network node assisted ML-based feature fallback. For example, a UE may be instructed by the network to perform ML-based feature fallback/switching.

In some embodiments, if the UE reports the simultaneous execution capability, upon receiving the UE capability information, the network node may send a first configuration message to instruct the UE to perform/operate a ML-based feature and its associated fallback feature simultaneously. The output of both features (ML-based and fallback features) may be used by the network node to perform performance monitoring or prediction of the ML-based feature using an instantaneous or short-term comparison.

To provide simultaneous feedback to the network according to the model and fallback outputs, the UE may be configured with special reporting modes and reserved reporting resources, e.g., repeating any relevant reporting procedure twice, once for the ML model and fallback features. Alternatively, the reporting may be configured so that ML-based and fallback-based output is signaled to the network according to a predetermined pattern, e.g., alternating. The parallel execution of fallback operation may be invoked at a low duty cycle, e.g., 5% of the total operation time, while most of the time the ML feature may be invoked alone.

In some embodiments, e.g., if the UE has indicated a lack of simultaneous execution capability, the UE may be configured to, e.g., operate alternately using the ML and fallback features and the performance monitoring may be done by long-term comparison of the two operating modes. The duration of the ML-based and fallback activity may be asymmetrical/unequal, with most of the time operating in the ML mode when no performance problems are detected. In some embodiments, the network node may base the performance monitoring of the ML feature on comparing with reference performance of high-level key performance indicators (KPIs), e.g., detecting a typical TP, SINR, serving beam selection, etc.

Upon detecting/predicting a performance failure of at least one ML-based feature for the associated functionality, the network node sends a second configuration message to instruct the UE to deactivate/stop/switch-off the ML-based feature and activate/switch-on the fallback feature for the associated functionality.

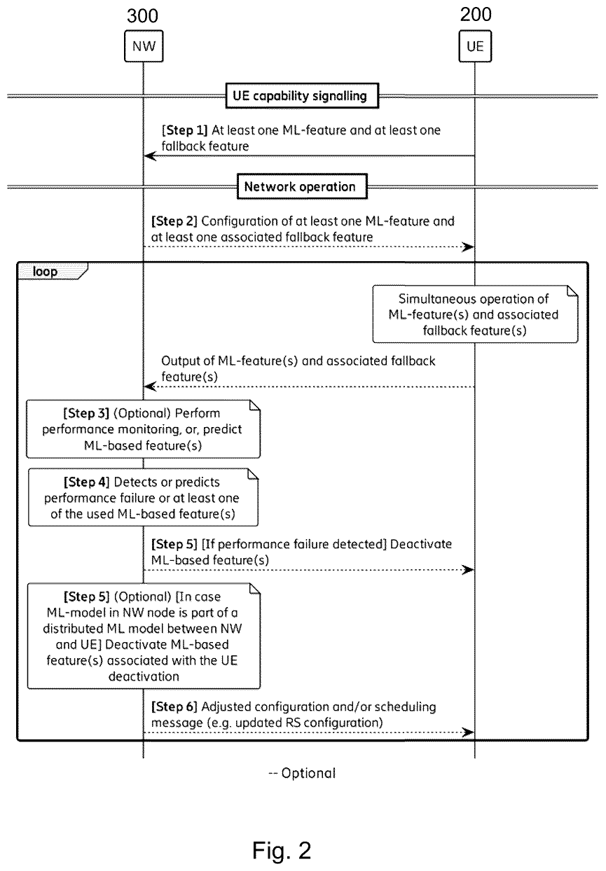

FIG. 2 is a flow chart illustrating an example of network node assisted ML-based feature fallback. Particular embodiments may include at least part of the following steps. The order of some steps may be interchanged, and some steps may be optional.

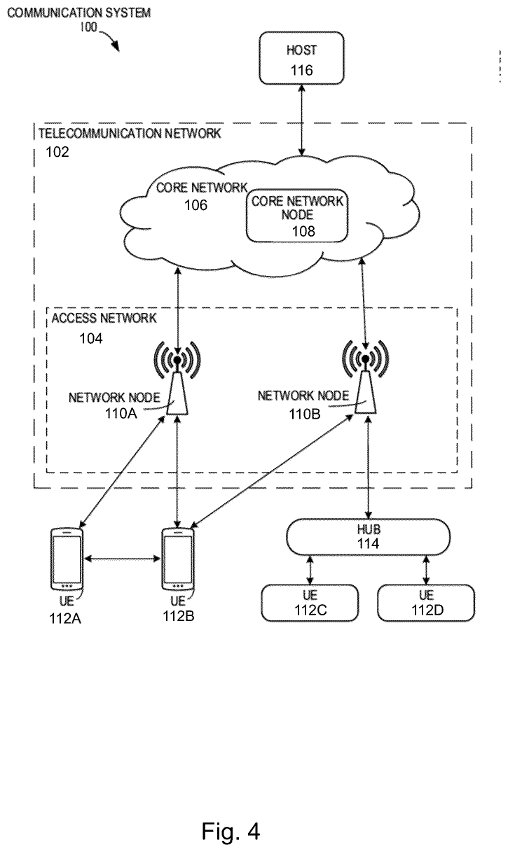

Step 1: A UE (e.g., UE 200 described in more detail below with respect to FIG. 4) sends a message to the network node (e.g., network node 300 described in more detail below with respect to FIG. 4) to indicate the UE capability of supporting a combination of at least one ML-based feature and at least one fallback feature for a functionality. The network node receives the message from the UE indicating the UE capability of supporting a combination of at least one ML-based feature and at least one fallback feature for a functionality.

Step 2 [Optional]: Upon receiving the UE capability information, the network node sends a first configuration message to instruct the UE to perform/operate at least one ML-based feature and its associated fallback feature simultaneously for the associated functionality. In response to receiving the message, the UE performs/operates the configured ML-based feature(s) and the fallback feature(s) simultaneously for the associated functionality.

Step 3 [Optional]: The network node uses the output of the ML-based feature(s) and the fallback feature(s) to perform performance monitoring or prediction of the ML-based feature(s).

Step 4: The network node detects or predicts a performance failure of at least one ML-based feature for the associated functionality.

Step 5: The network node sends a second configuration message to instruct the UE to deactivate/stop/switch-off the ML-based feature(s) that have performance issues and activate/switch-on the associated fallback feature(s). in response to the second message, the UE deactivates/stops/switches-off the indicated ML-based feature(s) that have performance issues and actives/switches-on the associated fallback feature(s).

Step 5 [Optional]: The network node deactivates/stops/switches-off the associated ML-models at the network side for at least the deactivated ML-based feature(s), e.g., for the case where the ML-based feature is based on a ML model that is split into two parts, with one part located at the UE and the other part located at the network, or for the case where the ML-based feature is based on multiple ML models, with part of the models located at the UE and the rest of the models located at the network.

Step 6 [Optional]: The network node sends an adjusted configuration or/and scheduling message to the UE. For example, the adjusted configuration message or/and scheduling message may include an updated reference signal resource configuration for UE measurements, or/and an updated CSI reporting configuration for the UE to report CSI using the fallback feature, etc.

Some embodiments include UE autonomous ML-based feature fallback where the UE reports its actions to the network node. For some use cases and with advanced UEs, a UE may monitor the ML-model performance of the one or more ML-based feature(s) and detects/predicts a ML-based feature issue by itself. In some embodiments, a UE autonomously performs ML-based feature fallback/switching and indicates that information to the network node.

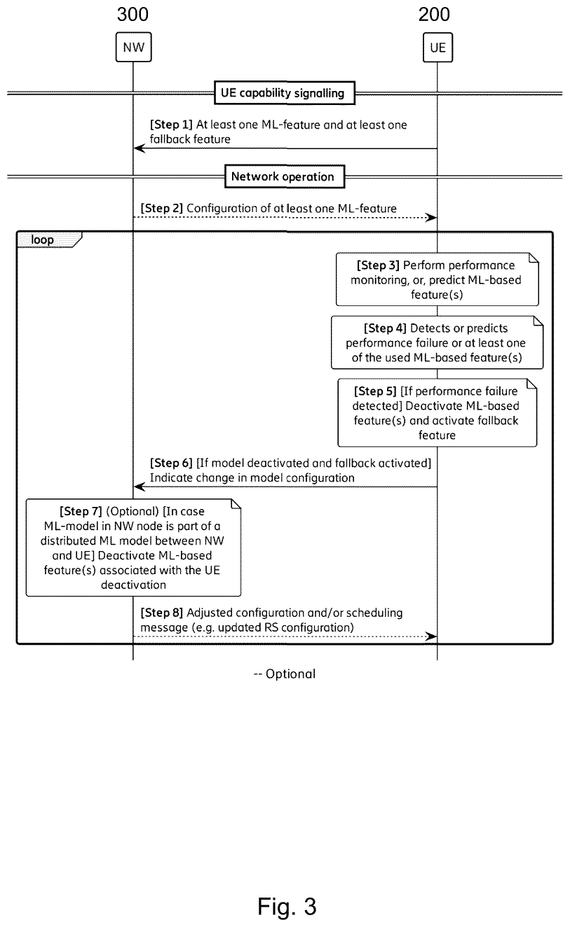

FIG. 3 is a flow chart illustrating an example of UE autonomous ML-based feature fallback and reporting its actions to the network node. Particular embodiments may include at least part of the following steps. The order of some steps may be interchanged, and some steps may be optional.

Step 1: A UE (e.g., UE 200 described in more detail below with respect to FIG. 4) sends a message to a network node (e.g., network node 300 described in more detail below with respect to FIG. 4) to indicate the UE capability of supporting a combination of at least one ML-based feature and at least one fallback feature for a functionality. The network node receives the message from the UE indicating the UE capability of supporting a combination of at least one ML-based feature and at least one fallback feature for a functionality.

Step 2: The network configures at least one ML-based feature.

Step 3: The UE monitors the ML-model performance of the one or more ML-based feature(s).

Step 4: The UE detects or predicts a performance failure of at least one ML-based feature for the associated functionality. Similar to the network-side performance monitoring approaches. In some embodiments, the UE may perform/operate a ML-based feature and its associated fallback feature simultaneously if it has the simultaneous execution capability. The UE may use the output of both features (ML-based and fallback features) to perform performance monitoring or prediction of the ML-based feature using an instantaneous or short-term comparison. The parallel operation may be invoked at a low duty cycle, e.g., 5% of the total operation time. Simultaneous execution may not strictly mean exactly at the same time rather that the same or very similar input data is used for both features to be able to compare the performance between the ML-based feature and the fallback feature, thus, the original data may need to be taken at the same time or at very close location in time.

For example, consider a use case where the functionality is about CSI report construction. The same CSI-RS resource set/index may act as the source data for the ML-based and fallback features, but the actual data processing processes for both features do not need to happen simultaneously. Rather, they can be spread out in time for later comparison about the result or reporting to the gNB.

In some embodiments, if the UE lacks the simultaneous execution capability, the UE may operate alternately using the ML and fallback features and the performance monitoring may be done by long-term comparison of the two operating modes. The duration of the ML-based and fallback activity may be asymmetrical/unequal, with most of the time operating in the ML mode when no performance problems are detected. In some embodiments, the UE may base the performance monitoring of the ML feature on comparing with reference performance of high-level KPIs, e.g., detecting a typical TP, SINR, serving beam quality, etc.

Step 5: The UE autonomously de-actives/stops at least the detected ML-based feature(s) that have performance issues and activates/switch-on the associated fallback feature(s).

Step 6: The UE indicates about the feature fallback/switching information (e.g., the de-activated/stopped/switched-off ML-based feature(s)) to the network node.

Step 7 [Optional]: The network node deactivates/stops/switches-off the associated ML-models at the network side for at least the deactivated ML-based feature(s), e.g., for the case where the ML-based feature is based on a ML model that is split into two parts, with one part located at the UE and the other part located at the network, or for the case where the ML-based feature is based on multiple ML models, with part of the models located at the UE and the rest of the models located at the network.

Step 8 [Optional]: The network node sends an adjusted configuration or/and scheduling message to the UE. For example, the adjusted configuration message or/and scheduling message may include an updated reference signal resource configuration for UE measurements, or/and an updated CSI reporting configuration for the UE to report CSI using the fallback feature, etc.

Although the examples described herein focus mainly on the UE capability reporting for the Uu interface, the same methodologies may be applied for supporting ML-based feature fallback using signalling between different UEs over the PC5 interface.

FIG. 4 illustrates an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

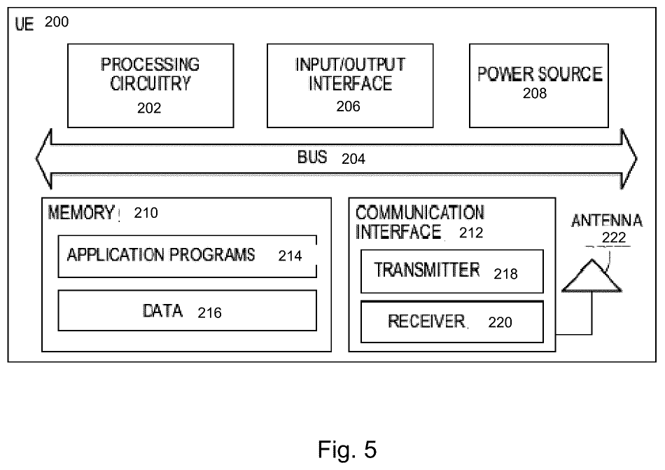

FIG. 5 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

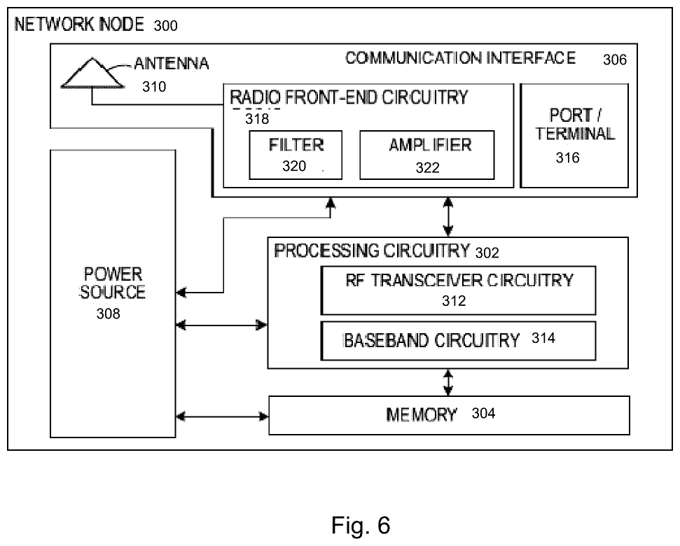

FIG. 6 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 6 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

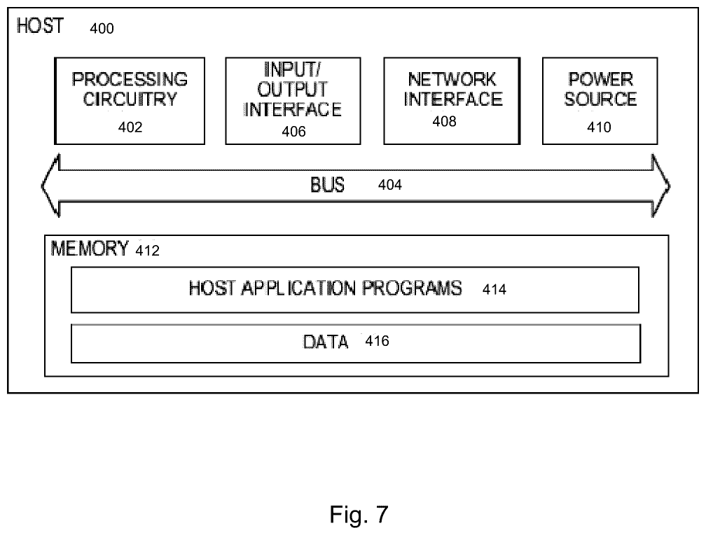

FIG. 7 is a block diagram of a host 400, which may be an embodiment of the host 116 of FIG. 4, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 3 and 4, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

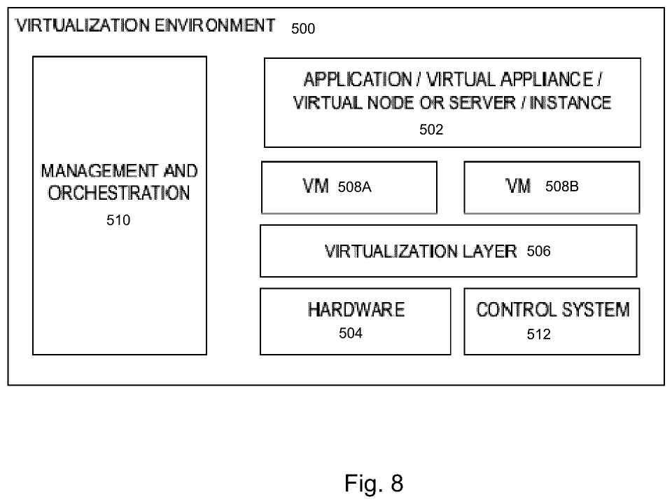

FIG. 8 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

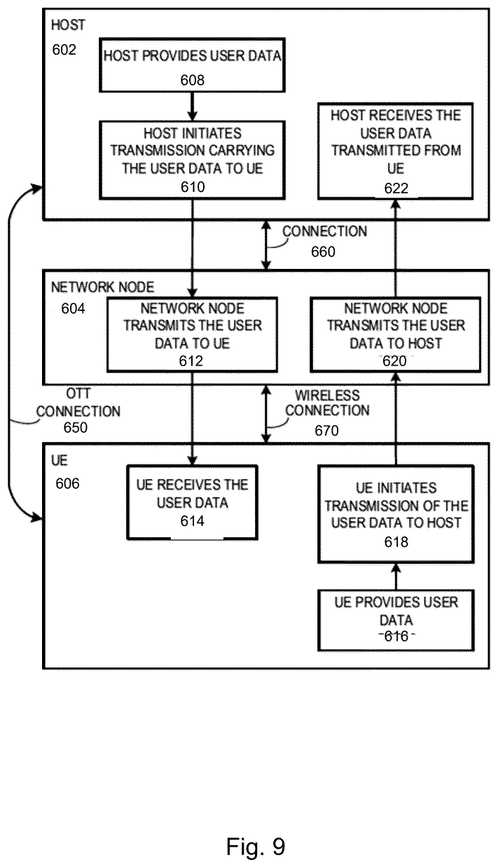

FIG. 9 shows a communication diagram of a host 602 communicating via a network node 604 with a UE 606 over a partially wireless connection in accordance with some embodiments. Example implementations, in accordance with various embodiments, of the UE (such as a UE 112a of FIG. 4 and/or UE 200 of FIG. 5), network node (such as network node 110a of FIG. 4 and/or network node 300 of FIG. 6), and host (such as host 116 of FIG. 4 and/or host 400 of FIG. 7) discussed in the preceding paragraphs will now be described with reference to FIG. 9.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 4) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the delay to directly activate an SCell by RRC and power consumption of user equipment and thereby provide benefits such as reduced user waiting time and extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

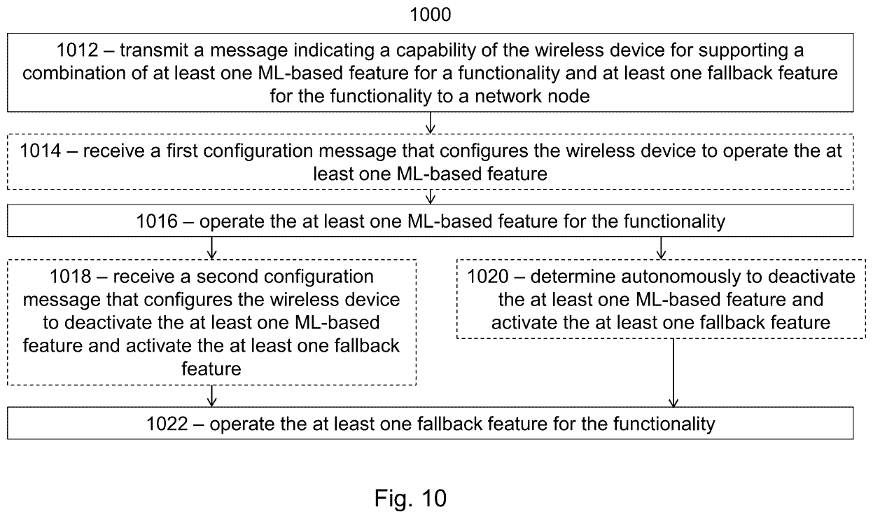

FIG. 10 is a flowchart illustrating an example method in a wireless device, according to certain embodiments. In particular embodiments, one or more steps of FIG. 10 may be performed by UE 200 described with respect to FIG. 5. The wireless device is capable of fallback operation of a ML model.

The method begins at step 1012, where the wireless device (e.g., UE 200) transmits a message indicating a capability of the wireless device for supporting a combination of at least one ML-based feature for a functionality and at least one fallback feature for the functionality to a network node.

In particular embodiments, the at least one ML-based feature is based on one ML model that is split in two parts, with one part located at the wireless device and the other part located at the network node.

In particular embodiments, the at least one fallback feature is a feature that fulfills comparable functionalities as the ML-based feature, but is not preferred compared to the ML-based feature. The at least one fallback feature may be a feature that has higher capabilities than the ML-based feature, but the fallback feature is not preferred. The at least one fallback feature may be based on a non-ML-based algorithm or it may be another ML-based algorithm (e.g., a more general purpose ML-based algorithm). Other examples of fallback features are described in the embodiments and examples above.

In particular embodiments, the message indicates whether the at least one fallback feature and the at least one ML-based feature may be executed simultaneously (e.g., to compare performance between the two).

At step 1014, the wireless device may receive a first configuration message that configures the wireless device to operate the at least one ML-based feature. In particular embodiments, the method further comprises receiving a first configuration message that configures the wireless device to operate the at least one ML-based feature and at least a fallback feature simultaneously. In other embodiments the wireless device may autonomously determine to operate the at least one ML-based feature and/or the at least one fallback feature and whether to operate simultaneously.

At step 1016, the wireless device operates the at least one ML-based feature for the functionality.

At step 1018, the wireless device may receive a second configuration message that configures the wireless device to deactivate the at least one ML-based feature and activate the at least one fallback feature.

In other embodiments, at step 10120, the wireless device determine autonomously to deactivate the at least one ML-based feature and activate the at least one fallback feature.

At step 1022, the wireless device operates the at least one fallback feature for the functionality.

Modifications, additions, or omissions may be made to method 1000 of FIG. 10. Additionally, one or more steps in the method of FIG. 10 may be performed in parallel or in any suitable order.

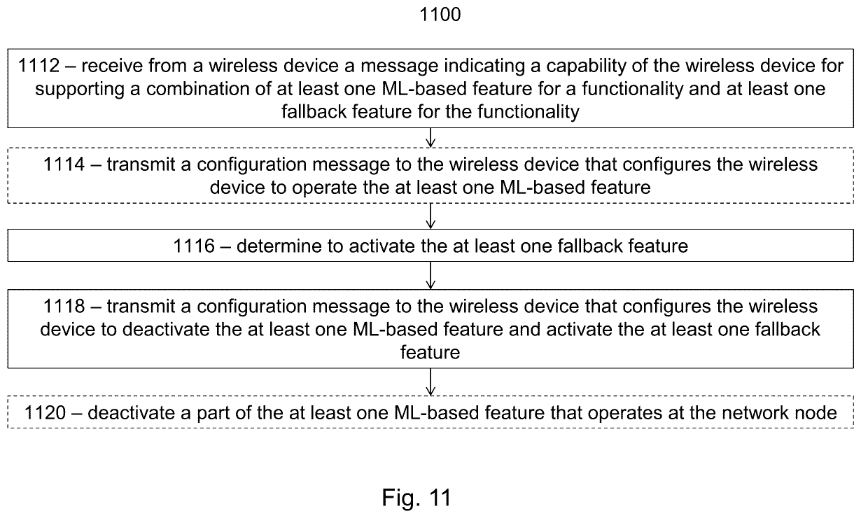

FIG. 11 is a flowchart illustrating an example method in a network node, according to certain embodiments. In particular embodiments, one or more steps of FIG. 11 may be performed by network node 300 described with respect to FIG. 6. The network node is operable to configuring a wireless device for fallback operation of a ML model.

The method begins at step 1112, where the network node (e.g., network node 300) receives from a wireless device a message indicating a capability of the wireless device for supporting a combination of at least one ML-based feature for a functionality and at least one fallback feature for the functionality.

In particular embodiments, the at least one ML-based feature is based on one ML model that is split in two parts, with one part located at the wireless device and the other part located at the network node.

In particular embodiments, the message indicates whether the at least one fallback feature and the at least one ML-based feature may be executed simultaneously.

At step 1114, the network node may transmit a configuration message to the wireless device that configures the wireless device to operate the at least one ML-based feature. In particular embodiments, the method further comprises transmitting (1114) a configuration message that configures the wireless device to operate the at least one ML-based feature and at least a fallback feature simultaneously.

At step 1116, the network node determines to activate the at least one fallback feature.

At step 1118, the network node transmits a configuration message to the wireless device that configures the wireless device to deactivate the at least one ML-based feature and activate the at least one fallback feature.

At step 1120, the network node may deactivate a part of the at least one ML-based feature that operates at the network node.

Modifications, additions, or omissions may be made to method 1100 of FIG. 11. Additionally, one or more steps in the method of FIG. 11 may be performed in parallel or in any suitable order.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1.-43. (canceled)

44. A method performed by a wireless device for fallback operation of a machine learning (ML) model, the method comprising:
Transmitting a message indicating a capability of the wireless device for supporting a combination of at least one ML-based feature for a functionality and at least one fallback feature for the functionality to a network node;
operating the at least one ML-based feature for the functionality; and
operating the at least one fallback feature for the functionality.

45. A wireless device capable of fallback operation of a machine learning (ML) model, the wireless device comprising processing circuitry operable to:
transmit a message indicating a capability of the wireless device for supporting a combination of at least one ML-based feature for a functionality and at least one fallback feature for the functionality to a network node;
operate the at least one ML-based feature for the functionality; and
operate the at least one fallback feature for the functionality.

46. The wireless device of claim 45, wherein the at least one ML-based feature is based on one ML model that is split in two parts, with one part located at the wireless device and the other part located at the network node.

47. The wireless device of claim 45, wherein the at least one fallback feature is a feature that fulfills comparable functionalities as the ML-based feature, but is not preferred compared to the ML-based feature.

48. The wireless device of claim 45, wherein the at least one fallback feature is a feature that has higher capabilities than the ML-based feature, but the fallback feature is not preferred.

49. The wireless device of claim 45, wherein the at least one fallback feature is based on a non-ML-based algorithm.

50. The wireless device of claim 45, wherein the at least one fallback feature is a ML-based algorithm.

51. The wireless device of claim 45, wherein the message indicates whether the at least one fallback feature and the at least one ML-based feature may be executed simultaneously.

52. The wireless device of claim 45, the processing circuitry further operable to receive a first configuration message that configures the wireless device to operate the at least one ML-based feature.

53. The wireless device of claim 45, the processing circuitry further operable to receive a first configuration message that configures the wireless device to operate the at least one ML-based feature and at least a fallback feature simultaneously.

54. The wireless device of claim 45, the processing circuitry further operable to receive a second configuration message that configures the wireless device to deactivate the at least one ML-based feature and activate the at least one fallback feature.

55. The wireless device of claim 45, further comprising determining autonomously to deactivate the at least one ML-based feature and activate the at least one fallback feature.

56. A method performed by a network node for configuring a wireless device for fallback operation of a machine learning (ML) model, the method comprising:
receiving from a wireless device a message indicating a capability of the wireless device for supporting a combination of at least one ML-based feature for a functionality and at least one fallback feature for the functionality;
determining to activate the at least one fallback feature; and
transmitting a configuration message to the wireless device that configures the wireless device to deactivate the at least one ML-based feature and activate the at least one fallback feature.

57. A network node capable of configuring a wireless device for concurrent operation of machine learning (ML) models, the network node comprising processing circuitry operable to:
receive from a wireless device a message indicating a capability of the wireless device for supporting a combination of at least one ML-based feature for a functionality and at least one fallback feature for the functionality;
detect performance degradation of the at least one ML-based feature; and
transmit a configuration message to the wireless device that configures the wireless device to deactivate the at least one ML-based feature and activate the at least one fallback feature.

58. The network node of claim 57, wherein the at least one ML-based feature is based on one ML model that is split in two parts, with one part located at the wireless device and the other part located at the network node.

59. The network node of claim 57, wherein the at least one fallback feature is a feature that fulfills comparable functionalities as the ML-based feature, but is not preferred compared to the ML-based feature.

60. The network node of claim 57, wherein the at least one fallback feature is a feature that has higher capabilities than the ML-based feature, but the fallback feature is not preferred.

61. The network node of claim 57, wherein the at least one fallback feature is based on a non-ML-based algorithm.

62. The network node of claim 57, wherein the at least one fallback feature is a ML-based algorithm.

63. The network node of claim 57, wherein the message indicates whether the at least one fallback feature and the at least one ML-based feature may be executed simultaneously.

64. The network node of claim 57, the processing circuitry further operable to transmit a configuration message to the wireless device that configures the wireless device to operate the at least one ML-based feature.

65. The network node of claim 57, the processing circuitry further operable to transmit a configuration message that configures the wireless device to operate the at least one ML-based feature and at least a fallback feature simultaneously.

66. The network node of claim 57, the processing circuitry further operable to deactivate a part of the at least one ML-based feature that operates at the network node.
